(19) United States
(12) Patent Application Publication
(10) Pub. No.: US 2025/0249428 A1
(43) Pub. Date: Aug. 7, 2025

(54) DUAL DEFECT ENGINEERED ZEOLITIC IMIDAZOLATE FRAMEWORK NANOPARTICLES, METHOD FOR PREPARING SAME, HYBRID MEMBRANE INCLUDING SAME, AND GAS SEPARATION METHOD USING SAME

(71) Applicant: SOGANG UNIVERSITY RESEARCH & BUISINESS DEVELOPMENT FOUNDATION, Seoul (KR)

(72) Inventors: Jong Suk LEE, Seoul (KR); Jeong Ho SEONG, Seoul (KR); He Seong AN, Seoul (KR); Ki Jin NAM, Seoul (KR); Gyu Heon SONG, Seoul (KR)

(21) Appl. No.: 19/016,705

(22) Filed: Jan. 10, 2025

(30) Foreign Application Priority Data
Feb. 2, 2024 (KR) 10-2024-0016821

(51) Int. Cl. B01J 20/26; B01D 53/04; B01J 20/28; B82Y 40/00

(52) U.S. Cl. CPC B01J 20/26; B01D 53/04; B01J 20/28007; B01J 20/2803; B01J 20/28033; B01J 20/28066; B01J 20/28071; B01J 20/28073; B82Y 40/00; B01D 2253/204; B01D 2253/306; B01D 2253/311

(57) ABSTRACT

The present disclosure relates to zeolitic imidazolate framework (ZIF) nanoparticles featuring a dual-defect structure, methods for their synthesis, hybrid membranes including the same, and a gas separation method using the same. The disclosed ZIF nanoparticles with dual-defect structures comprise: a metal ion coordinated with organic ligands, including an imidazolate-based organic ligand and an alkylamine-based organic ligand. The alkylamine-based organic ligand is further defined by the inclusion of two distinct alkylamines-a first alkylamine and a second alkylamine characterized by different alkyl chain lengths.

### CROSS-REFERENCE TO RELATED APPLICATION

This application claims the benefit of and priority to Korean Patent Application No. 10-2024-0016821, filed on Feb. 2, 2024, the entire disclosure(s) of which is hereby incorporated herein by reference in its entirety.

### BACKGROUND

### Field

The present disclosure relates to a zeolitic imidazolate framework (ZIF) having high permeability, a hybrid membrane including the same, a method for preparing the same, and a gas separation method using the same. Specifically, the present disclosure relates to a method for preparing a hybrid membrane by synthesizing nanoparticles in which a defect structure formed by a coordination bond between a metal and dual alkylamines is simultaneously introduced into ZIF formed by a coordination bond between a metal ion and 2-methylimidazole, and mixing the nanoparticles with a polymer, and a gas separation method using the hybrid membrane.

### Description of Related Art

Metal organic frameworks (MOFs) are crystalline structures with a large surface area, formed by organic ligands connected through regular coordination bonds with metal ions or clusters, creating a microporous structure.

MOFs are gaining attention as a material that can be applied in various fields such as catalysts, adsorbents for substances in various gaseous or liquid states, and membranes because their physical/chemical properties can be controlled by replacing the metal ions or organic ligands constituting the MOFs with other substances.

### RELATED ART DOCUMENT

[Patent Document]
(Patent Document 1) U.S. Pat. No. 9,527,872 B2

### SUMMARY

An object of the present disclosure is to develop novel ZIF nanoparticles capable of preparing a high-permeability hybrid membrane by simultaneously introducing heterogeneous alkylamines, and to provide a preparation method thereof, a hybrid membrane including the same, and a gas separation method using the hybrid membrane.

The object of the present disclosure is achieved by providing zeolitic imidazolate framework nanoparticles including dual defect structures, comprising: a metal ion; and an organic ligand bonded to the metal ion, wherein the organic ligand includes an imidazolate-based organic ligand and alkylamine-based organic ligands. The alkylamine-based organic ligands include a first alkylamine and a second alkylamine which have different alkyl chains.

The imidazolate-based organic ligand and the alkylamine-based organic ligands are directly bonded to the metal ion.

The number of carbon atoms of the first alkylamine is greater than that of the second alkylamine. Specifically, the number of carbon atoms of the first alkylamine may be 9 to 18, and the number of carbon atoms of the second alkylamine may be 3 to 9.

The first alkylamine and the second alkylamine are trialkylamines, and the number of carbon atoms of the first alkylamine may be 3 to 12 greater than that of the second alkylamine.

The metal ion may include zinc, the first alkylamine may include tributylamine, and the second alkylamine may include triethylamine.

The first alkylamine may be included in an amount of 2.0 to 4.5 mol, and the second alkylamine may be included in an amount of 0.5 to 2.5 mol, with respect to 100 mol of the imidazolate organic ligand.

The first alkylamine may be included in an amount of 2.3 to 3.0 mol, and the second alkylamine may be included in an amount of 1.0 to 2.0 mol, with respect to 100 mol of the imidazolate organic ligand.

The contents of the first alkylamine and the second alkylamine may be 1:0.40 to 1:0.70 in terms of a molar ratio.

The nanoparticles may have a specific surface area of 1200 to 1900 m²/g and a pore volume of 0.4 to 0.6 cm3/g.

Another object of the present disclosure is achieved by a method for preparing zeolitic imidazolate framework nanoparticles including dual defect structures, comprising steps of: preparing a first mixture by mixing a metal precursor and an imidazole-based ligand compound;

preparing a second mixture by mixing the first mixture with a polar solvent; and mixing the second mixture with an alkylamine ligand including a first alkylamine and a second alkylamine which have different numbers of carbon atoms.

The metal precursor includes an acetate salt of a metal, the amounts of the metal precursor: the imidazole-based ligand; and the alkylamine ligand used are 1:1.20 to 2.20:4 to 6 in terms of a molar ratio, and the amounts of the first alkylamine and the second alkylamine used may be 3:7 to 7:3 in terms of a molar ratio.

The metal precursor includes zinc acetate, the first alkylamine includes tributylamine, the second alkylamine includes triethylamine, and the amounts of the first alkylamine and the second alkylamine used may be 3:7 to 5:5 in terms of a molar ratio.

Another object of the present disclosure is achieved by a hybrid membrane including a polymer matrix; and nanoparticles according to any one of claims 1 to 9 dispersed in the polymer matrix.

The content of the nanoparticles in the membrane is 30% by weight to 60% by weight, and the polymer matrix may be formed by including any one selected from the group consisting of polyimide, polysulfone (PSF), polyethersulfone (PES), cellulose acetate (CA), polydimethylsiloxane (PDMS), and polyvinyl acetate (PVAc).

Another object of the present disclosure is achieved by a gas separation method

including a step of separating one or more gases from a mixed gas containing two or more gases using the hybrid membrane according to any one of claims 13 and 14.

According to the present disclosure, a novel ZIF nanoparticle having improved gas permeation performance by introducing heterogeneous alkylamines and a method for preparing the same, a hybrid membrane including the same, and a gas separation method using the hybrid membrane are provided.

### BRIEF DESCRIPTION OF THE DRAWING

FIG. 1 is a drawing explaining the concept of the present disclosure,

FIG. 2 shows an XRD pattern of nanoparticles synthesized in an Experimental Example of the present disclosure,

FIG. 3A to FIG. 3C are ToF-SIMS detection graphs of nanoparticles synthesized in an Experimental Example of the present disclosure,

FIG. 4A to FIG. 4C show FT-IR, (011) crystal plane change, and 77K N2 isotherm adsorption results of nanoparticles prepared in an Experimental Example of the present disclosure,

FIG. 5 shows scanning electron microscope images of nanoparticles prepared in an Experimental Example of the present disclosure,

FIG. 6 shows cross-sectional images of novel hybrid membranes prepared in Experimental Example of the present disclosure,

FIG. 7A to FIG. 7C present the zeta-potential results of nanoparticles synthesized in the Experimental Example of the present disclosure, along with the nano-indentation and ATR-IR results of the hybrid membrane prepared using the same nanoparticles.,

FIG. 8 is a graph showing single gas separation performances of C2H4 and C2H6 of novel hybrid membranes prepared in Experimental Example of the present disclosure,

FIG. 9 is results of comparatively analyzing single gas separation performances of C2H4 and C2H6 of hybrid membranes prepared in Experimental Example of the present disclosure and gas separation performances of reported hybrid membranes, and

FIG. 10 is results of analyzing gas separation performance of C2H4/C2H6 (50 mol %/50 mol %) mixed gas of the hybrid membrane prepared in the Experimental Example of the present disclosure.

### DETAILED DESCRIPTION

Hereinafter, the implementation examples and embodiments of the present disclosure will be described in detail so that those skilled in the art to which the present disclosure pertains can easily practice the present disclosure with reference to the attached drawings. However, the present disclosure may be implemented in various different forms and is not limited to the implementation examples and embodiments described herein. In addition, to clearly explain the present disclosure in the drawings, parts unrelated to the description are omitted, and similar parts are assigned similar drawing reference numerals throughout the specification.

Throughout the specification of the present disclosure, when a part is described as being “connected” to another part, this includes not only the case where it is “directly connected” but also the case where it is “indirectly connected” with another member being in the middle therebetween.

Throughout the specification of the present disclosure, when a member is described as being located “on” another member, this includes not only the case where a member is in contact with another member, but also the case where another member exists between the two members.

Throughout this specification of the present disclosure, when a part is said to “include” a component, it means that, unless otherwise specified, the part may include other components as well and does not exclude them.

The terms “about,” “substantially,” etc., as used in this specification, refer to values that are at or near the stated numerical value, considering manufacturing and material tolerances. These terms are also intended to prevent unscrupulous infringers from unfairly exploiting disclosures stated in exact or absolute values.

The terms of degree such as “˜ step” or “step of ˜” used throughout this specification do not mean “step for ˜.”

Throughout this specification, the term “combination(s) of these” as used in the Markushi format, refers to one or more mixtures or combinations selected from the group consisting of the components described in the Markush expression.

Throughout this specification, the description of “A and/or B” means “A or B, or A and B.”

Zeolite imidazolate framework-8 (ZIF-8) is a type of MOF composed of 2-methylimidazole and a zinc transition metal, and it is easy to control the pore size by varying the types of the constituent metal or organic ligand.

The present disclosure aims to develop a hybrid membrane for separating ethylene/ethane mixtures by introducing heterogeneous alkylamines of different molecular sizes, thereby inducing dual defect structures in nanoparticles and mixing them with a polymer matrix.

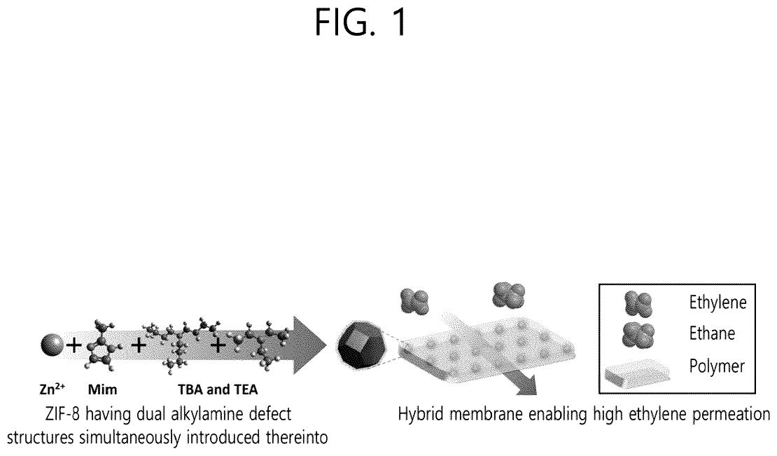

The present disclosure relates to a method for preparing a hybrid membrane for the separation of gases such as ethylene (C2H4)/ethane (C2H6), etc., comprising synthesizing nanoparticles having a zeolitic imidazolate framework (ZIF) by introducing metal ions, imidazole compounds, and heterogeneous alkylamines (alkylamine, AA) with different chain lengths in various amounts, as shown in FIG. 1, and mixing the nanoparticles with a polymer, as well as a gas separation method using the hybrid membrane.

The nanoparticles according to the present disclosure include a metal ion and an organic ligand bonded to the metal ion, where the organic ligand includes an imidazolate-based organic ligand and an alkylamine-based organic ligand. The alkylamine-based organic ligand includes a first alkylamine and a second alkylamine having different alkyl chains. Additionally, both the first and second alkylamines may be trialkylamines.

The imidazolate-based organic ligand and the alkylamine-based organic ligand are directly bonded to the metal ion.

The number of carbon atoms of the first alkylamine is greater than that of the second alkylamine. For example, the number of carbon atoms of the first alkylamine may be 9 to 18, and the number of carbon atoms of the second alkylamine may be 3 to 9.

Alternatively, the number of carbon atoms of the first alkylamine may be 3 to 12 greater than that of the second alkylamine.

The metal ion may include zinc, the first alkylamine may include tributylamine, and the second alkylamine may include triethylamine.

With respect to 100 moles of the imidazolate organic ligand, the first alkylamine may be included in an amount of 2.0 to 4.5 moles or 2.3 to 3.0 moles, and the second alkylamine may be included in an amount of 0.5 to 2.5 moles or 1.0 to 2.0 moles.

The contents of the first alkylamine and the second alkylamine may be 1:0.40 to 1:0.70 or 1:0.50 to 1:0.60 in terms of a molar ratio.

The nanoparticles may have a specific surface area of 1200 to 1900 m²/g or 1600 to

1900 m²/g, and a pore volume of 0.4 to 0.6 cm3/g.

Alkylamines may include ethylamine, propylamine, butylamine, diethyl amine, dipropyl amine, dibutyl amine, diethyl amine, tripropyl amine, tributyl amine, etc., but are not limited thereto.

Alkylamines include primary, secondary, and/or tertiary amines and include alkyl chains of various lengths.

The size of the nanoparticles may be 100 nm or less, and may be 5 nm to 100 nm or 5 nm to 50 nm, but is not limited thereto. The size of the nanoparticles may vary depending on the type of metal precursor used in the preparation process, but may be 100 nm or less, which is a particle size capable of exhibiting high gas separation performance while being suitable for the preparation of a mixed matrix membranes (MMMs). In general, the smaller the particle size, the more the specific surface area in contact with the polymer increases, which contributes to improving compatibility with the polymer. For example, the size of the nanoparticles may be about 100 nm or less, about 80 nm or less, about 60 nm or less, about 50 nm or less, about 40 nm or less, about 30 nm or less, about 20 nm or less, about 10 nm or less, about 1 nm to about 100 nm, about 5 nm to about 50 nm, or about 10 nm to about 30 nm, but is not limited thereto.

The nanoparticles may have improved dispersibility in an organic solvent, particularly an amphiphilic solvent. The organic solvent may be an amphiphilic solvent such as N-methyl pyrrolidone (NMP), dimethylformamide (DMF), etc., but is not limited thereto.

In one embodiment of the present disclosure, the nanoparticles may have a pore size of about 1 nm or less, or less than 1 nm. For example, the pore size of the nanoparticles including the zeolitic imidazolate framework may be about 0.1 nm to about 1 nm, about 0.1 nm to about 0.9 nm, about 0.1 nm to about 0.8 nm, about 0.1 nm to about 0.7 nm, about 0.1 nm to about 0.6 nm, about 0.1 nm to about 0.5 nm, about 0.2 nm to about 1 nm, about 0.2 nm to about 0.9 nm, about 0.2 nm to about 0.8 nm, about 0.2 nm to about 0.7 nm, about 0.2 nm to about 0.6 nm, or about 0.2 nm to about 0.5 nm, but is not limited thereto.

The present disclosure provides a hybrid membrane (composite film, composite membrane, hybrid film, membrane) in which nanoparticles are dispersed at a high concentration.

In one embodiment of the present disclosure, the content of nanoparticles dispersed in the polymer matrix in the hybrid membrane may be about 15% by weight, about 20% by weight, or 30% by weight or more based on the total weight of the membrane. For example, the content of the nanoparticles may be 15% by weight, 20% by weight, 30% by weight, 40% by weight, or 50% by weight or more based on the total weight of the membrane. The upper limit of the content may be 60% by weight, 70% by weight, or 80% by weight, but is not limited Specifically, the content of the nanoparticles in the membrane may be 30% by weight thereto. to 60% by weight.

The polymer used in the hybrid membrane of the present disclosure may include a general glassy or rubbery material. Specifically, it may include at least one of polyimide, polysulfone (PSF), polyethersulfone (PES), cellulose acetate (CA), polydimethylsiloxane (PDMS), and polyvinyl acetate (PVAc), but is not limited thereto. In addition, the polymer may also include a polymer of intrinsic microporosity.

In one embodiment of the present disclosure, the hybrid membrane may have a thickness of 50 nm or more, or 100 nm or more. The upper limit of the thickness may be 10 μm, 50 μm, 100 μm, 200 μm, or 500 μm, but is not limited thereto. In the case of a composite film freestanding film, it may be 10 μm or less, but is not limited thereto.

In one embodiment of the present disclosure, the hybrid membrane may be used as a membrane to separate one or more gases from a mixed gas containing two or more gases. For example, it may separate the gases from each other by utilizing the difference in molecular sizes of the gases contained in the mixed gas by passing the mixed gas through the hybrid membrane.

The difference in molecular sizes of the gases contained in the mixed gas may be about 0.1 Å to about 5 Å, but is not limited thereto.

The mixed gas may include a gas set selected from the group consisting of C₃H₆/C₃H₈,

C₂H₄/C₂H₆, CO₂/CH₄, CO₂/CO, CO₂/N₂, N₂/CH₄, and n-C₄/i-C₄ (n-butane/iso-butane) as well as H₂/CH₄, H₂/C₃H₆, H₂/C₃H₈, but is not limited thereto.

A method for preparing nanoparticles is as follows.

A first mixture is prepared by mixing a metal precursor and an imidazole-based ligand compound, and a second mixture is prepared by mixing the first mixture with a polar solvent.

Next, the second mixture is mixed with an alkylamine ligand including a first alkylamine and a second alkylamine which have different numbers of carbon atoms.

The metal precursor includes an acetate salt of a metal, and particularly includes zinc acetate.

The amount of metal precursor: imidazole-based ligand: alkylamine ligand used may be 1:1.20 to 2.20:4 to 6 in terms of a molar ratio, and the amounts of the first alkylamine and the second alkylamine used may be 3:7 to 7:3 in terms of a molar ratio.

The first alkylamine includes tributylamine, the second alkylamine includes triethylamine, and the amounts of the first alkylamine and the second alkylamine used may be 3:7 to 5:5 in terms of a molar ratio.

The metal precursor may include an acetate salt of one or more metals selected from the group consisting of Co, Zn, Sc, Ti, V, Cr, Mn, Fe, Ni, Cu, Y, Zr, Nb, Mo, Tc, Ru, Rh, Pd, Ag, Cd, Lu, Hf, Ta, W, Re, Os, Ir, Pt, Au, Hg, Lr, Rf, Db, Sg, Bh, Hs, Mt, Ds, Rg, and Uub, but is not limited thereto.

The imidazole-based ligand compound may include one or more selected from imidazole-based compounds represented by the following chemical formula 1 or chemical formula 2, but is not limited thereto:

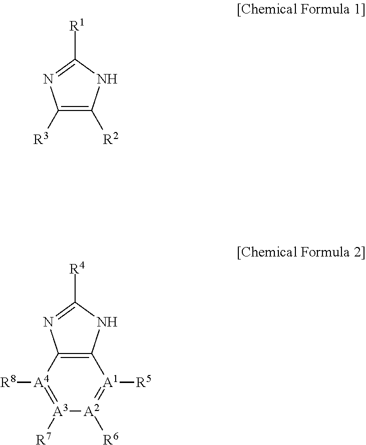

In each of Chemical Formulas 1 and 2,
R¹, R², R³, R⁴, R⁵, R⁶, R⁷, and R⁸ are each independently H, a C₁-C₁₀ linear or branched alkyl group, halogen, hydroxy, cyano, nitro, an aldehyde group, or a C₁-C₁₀ group, and

A¹, A², A³, and A⁴ are each independently C or N, provided that R⁵, R⁶, R⁷, and R⁸ exist only when A¹ and A⁴ are C.

The polar solvent may be methanol, but is not limited thereto.

The present disclosure will be described in more detail below through Experimental Example.

### Experimental Example Nanoparticle Preparation Method

[ZIF-8 Nanoparticles into which Dual Defect Structures are Simultaneously introduced]

The synthesis method of novel ZIF-8 nanoparticles (i.e., dual-defective alkylamine modulated ZIF-8, DAZIF-8) into which dual alkylamine defect structures are simultaneously introduced in the present disclosure, is as follows. A zinc acetate-based metal salt, an organic ligand (Mim), an amine modulator (TBA and Triethylamine (TEA)), and methanol were set to a synthesis molar ratio of 1:1.75:5:500, and among them, the molar ratio of the amine modulator corresponding to a synthesis molar ratio of 5 to zinc metal was varied into four different groups (TBA: TEA=4:1, 3:2, 2:3, 1:4). The zinc acetate-based metal salt and Mim were mixed in a 50 ml vial, left in the air at room temperature for a certain period of time, methanol was added thereto, and stirred at 800 rpm for 10 minutes under 65° C. conditions, and then an alkylamine (TBA and TEA) solution that was uniformly mixed was added thereto and stirred again for a day. Thereafter, formed white precipitate solution was purified using methanol and a centrifuge. After that, the particles were dried at 100° C. and 180° C. for 12 hours each under vacuum conditions to develop a final product, DAZIF-8 nanoparticles.

Control Group Nanoparticle Preparation Method

[ZIF-8 Nanoparticles]

The synthesis of ZIF-8 particles is as follows. A zinc nitrate metal salt, Mim, and methanol were set to a molar ratio of 1:8:500, and the zinc nitrate metal salt and Mim are each dissolved in methanol under room temperature conditions by stirring. Thereafter, each solution was uniformly mixed and stirred again at 800 rpm for one day under 40° C. conditions. A formed white precipitate solution was purified using methanol and a centrifuge. After that, the particles were dried under vacuum conditions at 100° C. and 180° C. for 12 hours each to develop a final product, ZIF-8 nanoparticles.

[ZIF-8 Nanoparticles Having Single-Defect Structure Introduced Thereinto]

The synthesis of ZIF-8 particles with single-defective alkylamine modulation (SAZIF-8), serving as a control group and incorporating a single alkylamine defect structure (TBA or TEA), is described as follows. A zinc acetate-based metal salt, Mim, an amine modulator (TBA or TEA), and methanol were set to a molar ratio of 1:1.75:5:500. TBA or TEA, corresponding to a molar ratio of 5:1 relative to the metal, was then added to synthesize two types of SAZIF-8 nanoparticles. The zinc acetate-based metal salt and Mim were mixed in a 50 ml vial, left in the air at room temperature for a certain period of time, methanol was added thereto, and stirred at 800 rpm for 10 minutes under 65° C. conditions, and then each TBA or TEA was added and stirred again for a day. A formed white precipitate solution was purified using methanol and a centrifuge. Afterwards, the particles were dried under vacuum conditions at 100° C. and 180° C. for 12 hours each to develop a final product, SAZIF-8 nanoparticles.

[ZIF-8 Nanoparticles with Controlled Synthesis Molar Ratio of Organic Ligand to Zinc Metal]

In order to check the particle synthesis yield and the concentration of alkylamine-based defect structure introduced according to the synthesis molar ratio of Mim to a zinc acetate-based metal salt, the synthesis molar ratio of Mim to zinc metal was set to 2.00, 1.75, 1.50, and 1.25. The synthesis thereof is as follows.

Four types of nanoparticles were synthesized by setting the molar ratio of a zinc acetate-based metal salt, an organic ligand (2-methylimidazole, Mim), an amine modulator (TBA), and methanol to 1:2:5:500, 1:1.75:5:500, 1:1.5:5:500, or 1:1.25:5:500. First, the zinc acetate-based metal salt and Mim were mixed in a 50 ml vial and left for a certain period of time. Then, methanol was added thereto and the mixture was stirred at 800 rpm for 10 minutes under 65° C. conditions. Thereafter, TBA was added thereto and the mixture was stirred again for a day. Afterwards, formed white precipitate solution was purified using methanol and a centrifuge. After that, the particles were dried at 100° C. and 180° C. for 12 hours each under vacuum conditions to synthesize a final product, AZIF-8 nanoparticles (i.e., Alkylamine modulated ZIF-8, AZIF-8).

[Particle Analysis 1-Control of Zinc Metal/Organic Ligand Synthesis Molar Ratio and Confirmation of Synthesis Yield of Novel Nanoparticles]

To introduce various defect structures based on dual alkylamines (TBA, TEA) into ZIF-8 crystals, novel ZIF-8 nanoparticles were synthesized by varying the synthesis molar ratio of Mim to a zinc acetate metal salt (Zn) into four groups (i.e., Zn: Mim=1:2.00, 1:1.75, 1:1.50, 1:1.25). Hereinafter, the name of the novel ZIF-8 nanoparticles synthesized by setting the synthesis molar ratio of TBA to Zn metal as 5:1 is as follows (i.e., AZIF-8 (x), where x is the synthesis molar ratio of Mim to Zn metal). It was confirmed that all novel AZIF-8 nanoparticles had about 8 mol % of TBA introduced into the structure due to the limited synthesis molar ratio of Mim to Zn metal (Table 1). This is an increase of about 2 mol % of TBA introduction compared to AZIF-8 (2.00) nanoparticles developed in a previous study. It is thought that the increased introduction amount of alkylamine-based defect structures was due to the more limited synthesis molar ratio of Mim (Zn: Mim=1:1.75, 1:1.50, 1:25) than the ideal synthesis molar ratio of Zn: Mim (Zn: Mim=1:2) constituting the ZIF-8 crystals used in the previous study. It was confirmed that the novel AZIF-8 nanoparticles had a difference in synthesis yield as the synthesis molar ratio of Mim to Zn metal decreased. It was confirmed that the synthesis yield decreased rapidly when the synthesis molar ratio of Mim to Zn metal decreased from 1.75 to 1.25 (synthesis yield of AZIF-8 (1.75): 81% vs. synthesis yield of AZIF-8 (1.25): 51%).

In the present disclosure, novel SAZIF-8 and DAZIF-8 nanoparticles, with single and dual defect structures introduced simultaneously, were synthesized by controlling the synthesis molar ratio of each TBA and TEA. This was performed using the synthesis molar ratio of Mim to Zn metal (Zn: Mim=1:1.75), which provides the highest introduction amount and synthesis yield of alkylamine defects. The names of the novel SAZIF-8 and DAZIF-8 particles were named as follows based on the actual concentration of TBA and TEA against total ligand in the crystals (e.g., SAZ-Bx (or SAZ-Ey) and DAZ-BxEy, where x represents a TBA introduction concentration (mol %) and y represents a TEA concentration (mol %)). SAZIF-8 nanoparticles having a single alkylamine defect structure introduced thereinto were synthesized to a synthesis molar ratio of Zn: Mim: TBA (or TEA)=1:1.75:5, and introduced concentrations of TBA and TEA were approximately 8 mol % and 4 mol %, respectively (Table 1). In the case of novel DAZIF-8 particles with dual alkylamine defect structures introduced simultaneously, they were synthesized using four different molar ratio of TBA and TEA (i.e., TBA: TEA=4:1, 3:2, 2:3, 1:4) and a synthesis molar ratio of Zn: Mim: (TBA and TEA)=1:1.75:5. In the case of DAZIF-8, which has dual alkylamines introduced simultaneously, unlike SAZIF-8, the structure with both TBA and TEA introduction into the structure was confirmed through 1H NMR analysis. The introduction of dual alkylamines was possible due to the similar pKa value of TBA and TEA, the alkylamine modulators used in the present disclosure (TBA pKa: 10.9 vs. TEA pKa: 10.75). Both the novel SAZIF-8 and DAZIF-8 synthesized under the condition of Zn: Mim: AA=1:1.75:5 showed a high synthesis yield (81%). Hereinafter, DAZ-B6E1 and DAZ-B1E2 among the synthesized DAZIF-8 particles were excluded from the subsequent characteristic evaluation because the introduction amount of one of the dual alkylamines was confirmed to be less than 1 mol %.

TABLE 1
Results of 1H NMR and content analysis of synthesized particles and yields

| Control | Organic ligand | | | | Experimental | Organic ligand | | | |
|---|---|---|---|---|---|---|---|---|---|
| group | content (mol %) | | | Synthesis | Example | content (mol %) | | | Synthesis |
| particle name | Mlm | TBA | TEA | yield (%) | particle name | Mlm | TBA | TEA | yield (%) |
| AZIF-8 | 94.1 | 5.9 | 0.0 | 97 | DAZ-B6E1 | 94.0 | 5.6 | 0.4 | 80 |
| (2.00) | | | | | | | | | |
| AZIF-8 | 92.5 | 7.5 | 0.0 | 68 | DAZ-B4E1 | 95.2 | 3.8 | 1.0 | 80 |
| (1.50) | | | | | | | | | |
| AZIF-8 | 92.4 | 7.6 | 0.0 | 51 | DAZ-B3E2 | 95.8 | 2.7 | 1.5 | 80 |
| (1.25) | | | | | | | | | |
| SAZ-B8 | 92.1 | 7.9 | 0.0 | 81 | DAZ-B1E2 | 96.9 | 0.8 | 2.3 | 81 |
| SAZ-E4 | 96.5 | 0.0 | 3.5 | 80 | | | | | |

[Particle Analysis 2-Confirmation of Crystallinity of Novel Nanoparticles]

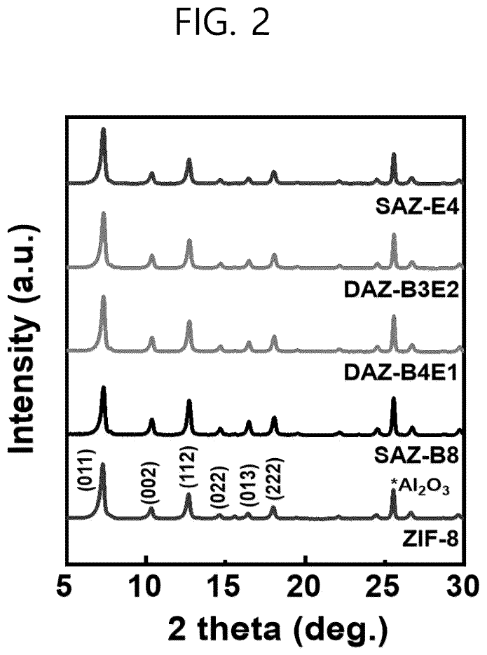

FIG. 2 shows results of powder X-ray diffraction (PXRD) analysis to determine whether SAZIF-8 and DAZIF-8 nanoparticles, with single and dual alkylamine defect structures introduced, exhibit crystallinity. The analysis results confirmed that all novel nanoparticles maintained a highly crystalline sodalite (SOD) structure regardless of the difference in the concentration of alkylamines.

[Particle Analysis 3-Analysis of Specific Surface Area and Pore Volume of Novel DAZIF-8 and SAZIF-8 Nanoparticles]

Table 2 shows results of analyzing the specific surface area and pore volume of each particle according to single and dual alkylamine defect structures by N₂ adsorption isotherms at 77 K. As a result of adsorption by N₂ BET, SAZ-B8 and SAZ-E4, into which each single TBA or TEA was introduced, showed a decrease in the specific surface area and pore volume compared to ZIF-8. On the other hand, DAZ-B3E2 (introduction of 3 mol % of TBA and 2 mol % of TEA) nanoparticles having dual alkylamine defect structures introduced simultaneously into the structure showed an increase in the specific surface area compared to ZIF-8, and showed the most microporous characteristics compared to the novel nanoparticles developed in this study.

TABLE 2
N₂ BET results (specific surface area and
pore volume) of the synthesized particles

| Sample name | Specific surface area (m² g⁻¹) | Pore volume (cm³ g⁻¹) |
|---|---|---|
| ZIF-8 | 1718 | 0.70 |
| SAZ-B8 | 707 | 0.21 |
| DAZ-B4E1 | 1327 | 0.24 |
| DAZ-B3E2 | 1745 | 0.53 |
| SAZ-E4 | 1035 | 0.40 |

[Particle Analysis 4-Analysis of the Presence or Absence of Coordination Bonds Between Metal Ions and Organic Ligands]

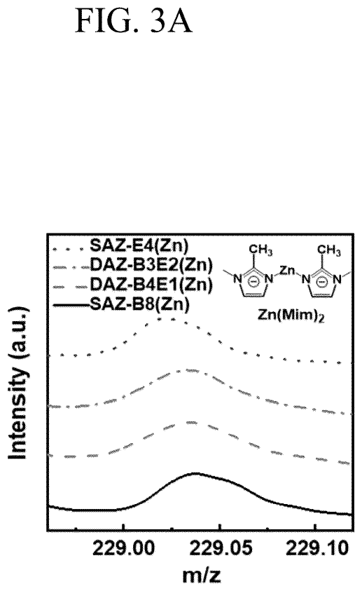

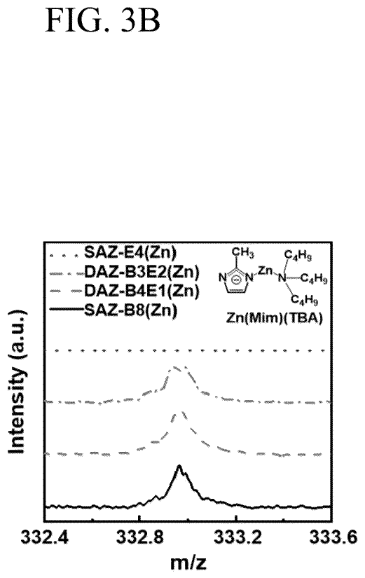

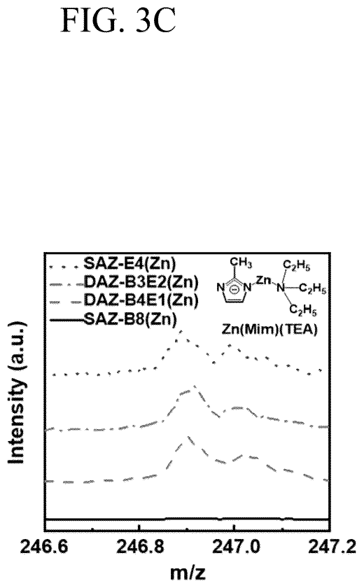

FIG. 3A to FIG. 3C show the presence or absence of coordination bonds between Zn2+ and each organic ligand in the novel SAZIF-8 and DAZIF-8 crystals through time-of-flight secondary ion mass spectrometry (ToF-SIMS), a surface characteristic analysis. The names shown in 3A to FIG. 3C, (a): Zn (Mim) 2=229.0, (b): Zn (Mim) (TBA)=332.9, and (c): Zn (Mim) (TEA)=246.9 (m/z), are results of detecting coordination bonds between Zn2+ and each organic ligand in a specific mass analysis range. The analysis results of FIG. 3A confirmed that Zn (Mim) 2 bonds forming the SOD structure were presented in both SAZIF-8 and DAZIF-8, into which single and dual alkylamines were introduced. FIG. 3B and FIG. 3C show the presence or absence of coordination bonds between each Zn2+ and alkylamine (TBA or TEA). As a result of the analysis, it was confirmed that there are specific wavelength peaks of Zn (Mim) (TBA) and Zn (Mim) (TEA) according to the defect structure morphology of Zn2+ and each alkylamine. For example, it was confirmed that the Zn (Mim) (TBA) peak appeared at 332.9 (m/z) in the case of SAZ-B8, DAZ-B4E1, and DAZ-B3E2 nanoparticles into which Zn-TBA was introduced, and the Zn (Mim) (TEA) peak appeared at 246.9 (m/z) in the case of SAZ-E4, DAZ-B4E1, and DAZ-B3E2 nanoparticles into which Zn-TEA was introduced.

This means that TBA and TEA used to induce the defect structure are capable of coordination bonding with Zn2+ ions.

[Particle Analysis 5-Novel Particle Characterization Evaluation According to Alkylamine Defect Structure Morphology]

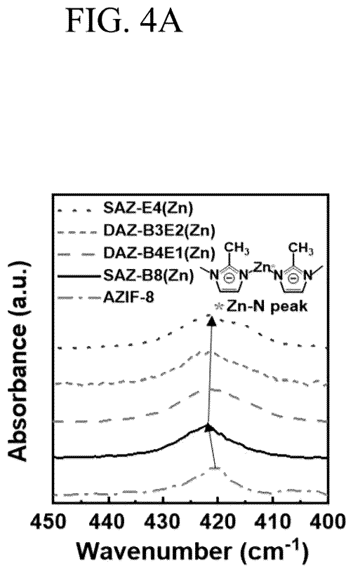

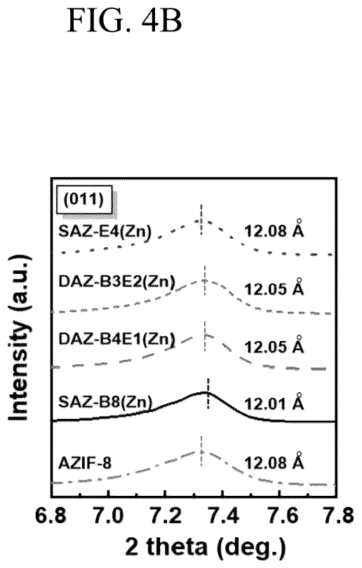

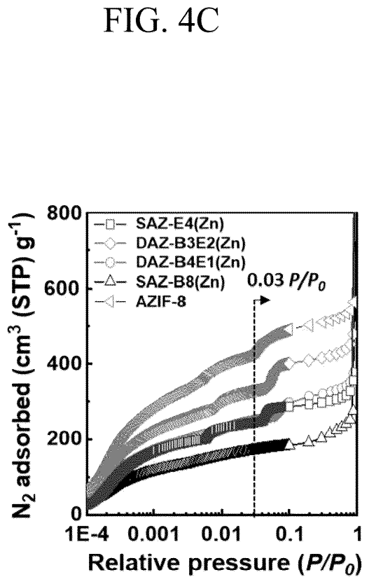

FIG. 4A shows the physical bonding strength between Zn2+ ions and organic ligands (M-L) in the SAZIF-8 and DAZIF-8 structures through Fourier transform infrared (FT-IR). As analysis results, the novel SAZIF-8 and DAZIF-8, synthesized at a synthesis molar ratio of Mim to Zn of 1:1.75, were both blue-shifted in the wavenumber of the M-L peak compared to the previously studied AZIF-8. This means that the introduction of various alkylamine defect structures into the SAZIF-8 and DAZIF-8 structures increased the bonding strength of M-L. The SAZIF-8 and DAZIF-8 particles showed different Zn-Mim bonding strengths according to alkylamine defect structure morphologies in the structure. A phenomenon that the M-L bonding strength decreased as the concentration of TEA introduced into the novel nanoparticle structure increased was confirmed. Comparing the pKa of organic ligands, which are indicators that can predict the physical bonding strength of M-L in ZIF-8, it is thought that TEA has a relatively low pKa compared to TBA, which weakens the physical bonding strength with Zn2+ (TBA pKa: 10.89 vs. TEA pKa: 10.75).

FIG. 4B shows results of XRD analysis of the (011) crystal plane spacing of each particle to confirm the change in the characteristics of novel particles due to the introduction of TBA and TEA, which have different physical/chemical properties. In the case of SAZ-B8 (Zn) nanoparticles having 2 mol % of Zn-TBA additionally added compared to AZIF-8 in the previous study, they showed the decreased (011) crystal plane spacing. This means that as the Zn-TBA defect structure in the ZIF-8 structure increases, the (011) interplanar spacing, which plays an important role in gas permeation, gradually decreases. On the other hand, the (011) crystal plane spacing is shown to increase as the concentration of Zn-TEA introduced into the structure increases.

FIG. 4C shows results of analysis using a Brunauer-Emmett-Teller (BET) analyzer to analyze the extent of organic ligand flipping-motion in novel SAZIF-8 and DAZIF-8 nanoparticles with various alkylamine-based defect structures introduced thereinto. The gate-opening pressures of the conventional ZIF-8 and AZIF-8 particles are shown to be in a range of approximately 0.02 and 0.03 P/Po due to the flipping-motion between Zn2+ and Mim under N₂ BET 77 K conditions. On the other hand, the gate-opening pressures of the novel SAZIF-8 and DAZIF-8 nanoparticles were both blue-shifted compared to AZIF-8. This is because after the introduction of alkylamines (TBA and TEA) with relatively large molecular weights compared to Mim, the flipping-motion of organic ligands was restricted, thereby forming a pore structure with enhanced sieving effect. In addition, it was confirmed that the SAZ-B8 nanoparticles having approximately 8 mol % of Zn-TBA defect structures introduced thereinto disappeared from the gate-opening phenomenon.

[Particle Analysis 6-Scanning Electron Microscopy Analysis]

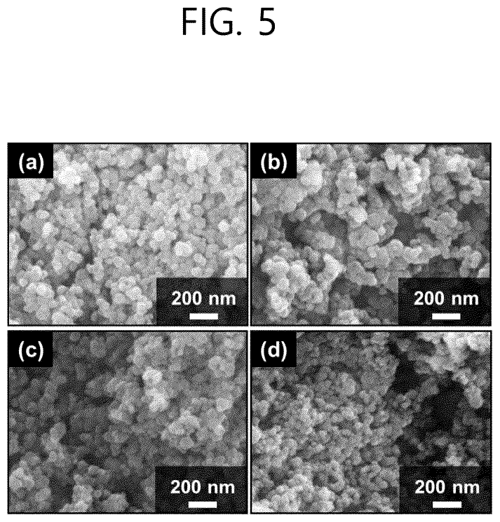

FIG. 5 is scanning electron microscope images of the novel SAZIF-8 and

DAZIF-8 nanoparticles. The novel SAZIF-8 and DAZIF-8 nanoparticles all showed a uniform particle size of approximately 70 nm regardless of the alkylamine defect concentration.

[Preparation Method of Novel Hybrid membranes]

Hybrid membranes (mixed matrix membranes, MMMs) were prepared by mixing novel nanoparticles of SAZ-B8, DAZ-B4E1, DAZ-B3E2, and SAZ-E4, respectively, with 6FDA-DAM polyimide based polymer at a weight ratio of 60 (polymer)/40 (nanoparticles). The novel SAZIF-8 and DAZIF-8 nanoparticles were evenly dispersed in each N-methyl-2-pyrrolidone (NMP) solvent through each ultrasonicator, and then 6FDA-DAM (PI) polymer was added thereto to prepare a dope solution uniformly mixed with the polymer through roller treatment for 12 hours. After that, the prepared dope solution was cast into a thin layer of approximately 35 to 45 μm on a flat glass plate using a doctor blade and dried in a vacuum oven under conditions of 70° C. and 12 hours. Afterwards, additional drying was performed under conditions of 120° C. and 24 hours in order to remove residual NMP solvent in the hybrid membrane. The names of the novel high-concentration (>40 wt %) hybrid membranes are named as follows. Examples of hybrid membrane names having single alkylamine and dual alkylamine structures introduced thereinto: PSAZ-Bx (40) (or PSAZ-Ey (40)) and PDAZ-BxEy (40), where x and y mean the actual introduced amounts (mol %) of TBA and TEA, respectively.

[Scanning Microscope Images of Hybrid Membranes Containing High-Concentration Particles (>40 wt %)]

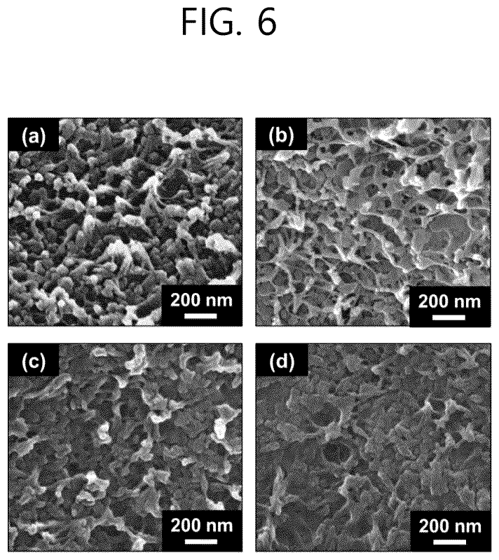

FIG. 6 is scanning electron microscope images of photographing cross-sections of the novel high-concentration (>40 wt %) PSAZ and PDAZ MMM. The novel particles having single and dual alkylamine defect structures introduced thereinto were confirmed to exhibit excellent compatibility without an agglomeration phenomenon of the particles in the high-concentration hybrid membrane and non-selective voids at the interface with the PI polymer due to excellent dispersibility in NMP solvent.

### [Analysis of Surface Charges and Hybrid Membrane Characteristics of Novel Nanoparticles]

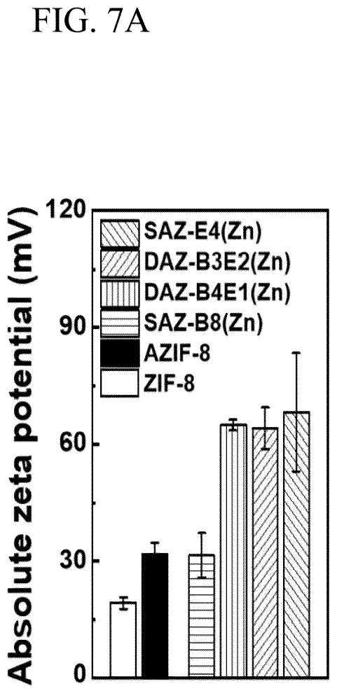

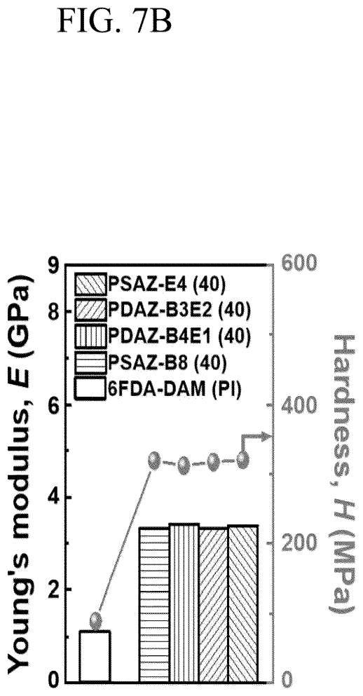

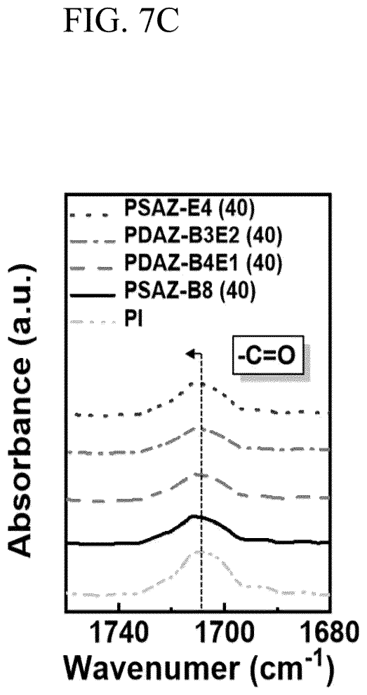

In order to elucidate the excellent dispersibility of the novel SAZIF-8 and DAZIF-8, the surface charge layers of ZIF-8 and each novel nanoparticle in the NMP solvent were analyzed through zeta-potential analysis. All of the AZIF-8 and novel nanoparticles (SAZIF-8 and DAZIF-8) from the previous study showed higher absolute surface charge layers than the existing ZIF-8. This is because the particle size was reduced to 100 nm or less due to the fast coordination reaction effect of the alkylamine modulator used during the synthesis of nanoparticles in this study, which increased the specific surface area per unit volume, and thus the surface charge intensity was further enhanced compared to ZIF-8. It is thought that this greatly enhanced the repulsive force between particles in the NMP solvent, resulting in excellent dispersibility. In particular, it was observed that the negative charged surface charge layer was enhanced as the concentration of TEA introduced into the novel nanoparticle structure increased (FIG. 7A).

FIG. 7B shows results of analyzing the novel PSAZ (40) and PDAZ (40) MMMs through nano-indentation and ATR-IR analyses in order to confirm the interfacial intimacy between the PI polymer and the novel nanoparticles. The novel SAZIF-8 and DAZIF-8 nanoparticles having various alkylamine-based defect structures introduced thereinto showed significantly improved Young's modulus and hardness, which represent the physical strength of MMMs, by 200% and 250%, respectively, compared to the pristine PI polymer due to the excellent interfacial intimacy with the PI polymer. In addition, in order to confirm the enhanced chemical interaction between the novel nanoparticles having alkylamine defect structures introduced thereinto and the PI polymer, the PSAZ (40) and DPAZ (40) MMMs were analyzed by attenuated total reflectance (ATR) (FIG. 7C). The analysis results confirmed that the carbonyl group (-C—O) peak of PSAZ (40) and PDAZ (40) MMMs appearing in the range of 1740-1680 cm-1 tended to blue shift compared to PI. This is because the partially negatively charged-C═O group in the PI polymer skeleton can be subjected to a preferential chemical interaction with the alkyl chain (-CH₃) group in the partially positively charged alkylamine modulator.

[Measurement of Single Gas (C₂H₄ and C₂H₆) Permeation Performances of Novel Hybrid Membranes]

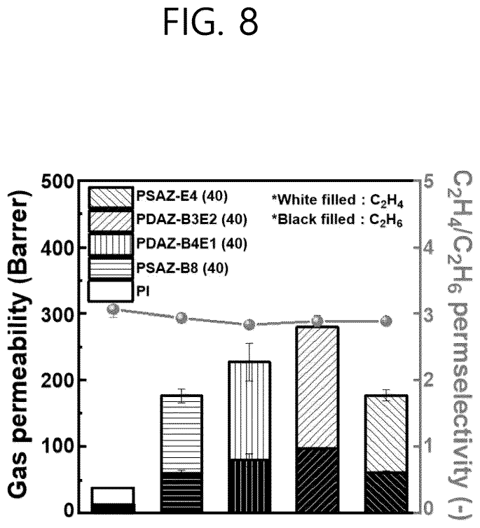

Table 3 and FIG. 8 show the single gas separation performance of C₂H₄ and C₂H₆ for PSAZ (40) and PDAZ (40) MMMs, having PI polymer, single alkylamine, and dual alkylamine defect structures introduced thereinto under 2 atm and 35° C. conditions. The analysis results confirmed that the novel PSAZ (40) and PDAZ (40) MMMs had similar C₂H₄/C₂H₆ selectivities (˜3) compared to pristine PI polymers. It was confirmed that the C₂H₄ permeability increase rates of PSAZ-B8 (40) and PSAZ-E4 (40) MMMs having single alkylamine defect structures introduced thereinto were improved to about 457% and 495%, respectively, whereas the C₂H₄ permeability increase rate of PDAZ-B3E2 MMM having dual alkylamine defect structures simultaneously introduced thereinto was significantly improved to 759%. This means that a pore structure suitable for high C₂H₄ permeability is formed according to the simultaneous introduction of dual alkylamine defect structures into the ZIF-8 structure.

TABLE 3
Single C₂H₄/C₂H₆ gas separation performance
of PI, PSAZ (40), and PDAZ (40) MMMs under
isothermal conditions of 2 atm and 35° C.

| | Particle | | | |
|---|---|---|---|---|
| Sample | content | | | |
| name | (wt %) | C₂H₄ (Barrer) | C₂H₆ (Barrer) | C₂H₄/C₂H₆ (−) |
| PI | — | 37.0 | 11.7 | 3.15 |
| PSAZ-B8 | 40 | 169 | 56.4 | 2.99 |
| PDAZ-B4E1 | 40 | 247 | 86.9 | 2.84 |
| PDAZ-B3E2 | 40 | 281 | 95.3 | 2.95 |
| PSAZ-E4 | 40 | 183 | 63.1 | 2.90 |

Table 4 presents the single gas separation performance (CO₂, N₂, and CH₄) of the PI polymer, PSAZ (40), and PDAZ (40) MMMs under conditions of 1 atm and 35° C. It was confirmed that the CO₂/N₂ and CO₂/CH₄ selectivities of the newly manufactured PSAZ (40) and PDAZ (40) MMMs were lower than those of PI. This reduction is attributed to the structural flexibility caused by the flipping-motion of the organic ligands in the ZIF-8 structure, making them less suitable for CO₂/CH₄ sieving separation. However, both PSAZ (40) and PDAZ (40) MMMs exhibited improved CO₂ permeability compared to PI. Notably, the PDAZ-B3E2 (40) MMM, having dual alkylamine structures, simultaneously introduced thereinto showed the highest CO₂ permeability (1660 Barrer).

TABLE 4
CO₂/N₂ and CO₂/CH₄ gas separation performance of PI and hybrid
membranes under isothermal conditions at 1 atm and 35° C.

| | Particle | | | | | |
|---|---|---|---|---|---|---|
| Sample | content | Permeability (Barrer) | | | Selectivity (−) | |
| name | (wt %) | CO₂ | N₂ | CH₄ | CO₂/N₂ | CO₂/CH₄ |
| PI | — | 507 | 23.4 | 19.9 | 21.6 | 25.4 |
| PSAZ-B8 | 40 | 1165 | 106 | 105 | 11.0 | 11.1 |
| PDAZ- | 40 | 1475 | 130 | 127 | 11.3 | 11.6 |
| B4E1 | | | | | | |
| PDAZ- | 40 | 1660 | 145 | 140 | 11.4 | 11.8 |
| B3E2 | | | | | | |
| PSAZ-E4 | 40 | 1445 | 112 | 110 | 12.9 | 13.1 |

Based on the C₂H₄ and C₂H₆ single gas permeation performances of FIG. 8, the diffusivity and solubility of each gas were divided and shown in Table 5. In a dense polymer membrane, the gas permeability (Pi) may be expressed as the product of the diffusivity (Di), a dynamic factor, and the solubility (Si), a thermodynamic factor, as follows.

$${P}_{i} = {D}_{i} \times {S}_{i}$$

As shown in Table 5, in the case of PDAZ (40) MMM having dual alkylamine defect structures simultaneously introduced thereinto, the gas diffusivity of each of C₂H₄ and C₂H₆ was confirmed to increase significantly compared to PSAZ (40) MMM having a single alkylamine introduced thereinto. On the other hand, in the case of solubility, it was confirmed that similar values were maintained for all hybrid membranes. As a result of comparative analysis of the C₂H₄/C₂H₆ diffusivity selectivity and C₂H₄/C₂H₆ solubility selectivity of each MMM, it was confirmed that the C₂H₄/C₂H₆ solubility selectivity was lower than 1, which means that there was no selective chemical interaction between the newly manufactured MMMs and C₂H₄. On the other hand, it was confirmed that the C₂H₄/C₂H₆ diffusivity selectivities of the novel MMMs were all improved compared to PI.

TABLE 5
Diffusivities, solubilities, diffusivity selectivities,
and solubility selectivities of C₂H₄ and C₂H₆ gases of
the developed hybrid membranes containing 40 wt % of nanoparticles
under isothermal conditions at 35° C. and 2 atm

| | | | | Diffusivity | Solubility |
|---|---|---|---|---|---|
| | | Diffusivity | Solubility | selectivity | selectivity |
| Sample | Gas | (Dᵢ^{a}) | (Sᵢ^{b}) | C₂H₄/C₂H₆ | C₂H₄/C₂H₆ |
| PI | C₂H₄ | 15.5 | 2.38 | 3.40 | 0.93 |
| | C₂H₆ | 4.57 | 2.57 | | |
| PSAZ-B8 | C₂H₄ | 58.5 | 2.88 | 3.80 | 0.79 |
| (40) | C₂H₆ | 15.4 | 3.67 | | |
| PDAZ- | C₂H₄ | 76.4 | 3.23 | 3.59 | 0.79 |
| B4E1 (40) | C₂H₆ | 21.3 | 4.08 | | |
| PDAZ- | C₂H₄ | 91.6 | 3.06 | 3.93 | 0.75 |
| B3E2 (40) | C₂H₆ | 23.3 | 4.08 | | |
| PSAZ-E4 | C₂H₄ | 71.2 | 2.57 | 3.89 | 0.75 |
| (40) | | | | | |

*^{a}Diffusivity (×10⁻⁹ cm² sec⁻¹)
*^{b}Solubility (×10⁻¹ cm³ (STP) cm⁻³ cmHg⁻¹)

[Comparison of Single C₂H₄ and C₂H₆ Gas Performances of Novel Hybrid Membranes]

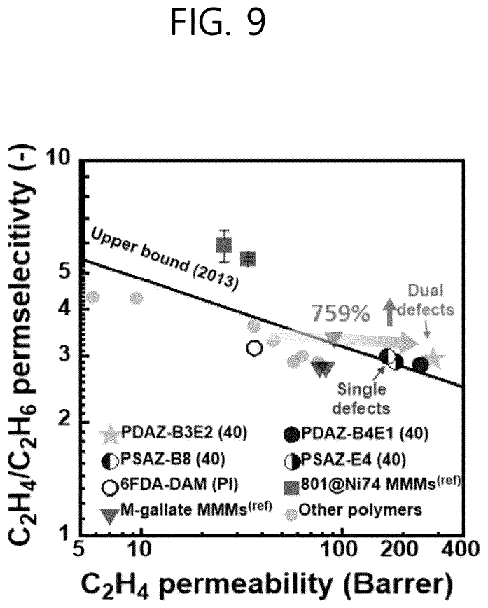

FIG. 9 compares the C₂H₄/C₂H₆ separation performance of the PDAZ-B3E2 (40) hybrid membrane developed in the present disclosure with the separation performance of various polymer membranes (Ref 1_Polymer, 1.J. Mater. Chem. A, 2018, 6, 18912) and MMMs (Ref 2_Jeffry, Appl. Mater. Interfaces, 2019, 11, 18377, Ref 3_Ni-gallate, 3.10-2019-0129543) recently reported. The PDAZ-B3E2 (40) membrane, containing 40 wt % of DAZ-B3E2 nanoparticles with dual alkylamine defect structures, exhibited the highest C₂H₄ permeability among the compared membranes. It showed an approximately 759% improvement in C₂H₄ permeability compared to PI.

[Confirmation of C₂H₄/C₂H₆ (50 Mol %/50 Mol %) Mixed Gas Separation Performances and Excellent Plasticization Resistances]

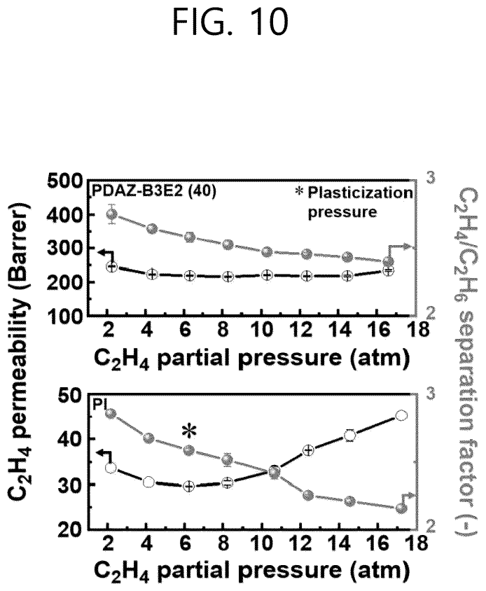

FIG. 10 shows the mixed gas separation performance of PI polymer and PDAZ-B3E2 (40) MMM as a function of C₂H₄ partial pressure, using C₂H₄/C₂H₆ mixture (50 mol %/50 mol %) at 35° C. As a result of the analysis, compared to the single gas separation performance of C₂H₄ and C₂H₆, the mixed gas separation performance of the PI polymer and PDAZ-B3E2 (40) MMM showed a 9% and 13% decrease in C₂H₄ permeability and a 9.2% and 6.8% decrease in C₂HA/C₂H₆ selectivity, respectively. This decrease is attributed to competitive sorption during mixed gas permeation. It was observed that the pristine PI membrane showed a rapid increase in C₂H₄ permeability after the C₂H₄ partial pressure exceeded 6 atm under the mixed gas conditions of C₂H₄/C₂H₆ (50 mol %/50 mol %). This was 5 due to the plasticization of the PI polymer by the highly condensable C₂H₄ gas. In contrast, the PDAZ-B3E2 (40) MMM maintained C₂H₄ permeability up to a C₂H₄ partial pressure of 16 atm, attributed to the suppression of plasticization as a result of the improved interfacial interactions between the PI polymer and the DAZ-B3E2 nanoparticles.

1. Zeolitic imidazolate framework nanoparticles including dual defect structures, the nanoparticles comprising:
a metal ion; and
an organic ligand bonded to the metal ion,
wherein the organic ligand includes an imidazolate-based organic ligand and an alkylamine-based organic ligand, and the alkylamine-based organic ligand includes a first alkylamine and a second alkylamine which have different alkyl chain lengths.

2. The nanoparticles of claim 1, wherein the imidazolate-based organic ligand and the alkylamine-based organic ligand are directly bonded to the metal ion.

3. The nanoparticles of claim 2, wherein the number of carbon atoms of the first alkylamine is greater than that of the second alkylamine, and the number of carbon atoms of the first alkylamine is 9 to 18, and the number of carbon atoms of the second alkylamine is 3 to 9.

4. The nanoparticles of claim 3, wherein the first alkylamine and the second alkylamine are trialkylamines, and the number of carbon atoms of the first alkylamine is 3 to 12 greater than that of the second alkylamine.

5. The nanoparticles of claim 4, wherein the metal ion includes zinc, the first alkylamine includes tributylamine, and the second alkylamine includes triethylamine.

6. The nanoparticles of claim 3, wherein the first alkylamine is included in an amount of 2.0 to 4.5 mol, and the second alkylamine is included in an amount of 0.5 to 2.5 mol, with respect to 100 mol of the imidazolate organic ligand.

7. The nanoparticles of claim 6, wherein the first alkylamine is included in an amount of 2.3 to 3.0 mol, and the second alkylamine is included in an amount of 1.0 to 2.0 mol, with respect to 100 mol of the imidazolate organic ligand.

8. The nanoparticles of claim 3, wherein the contents of the first alkylamine and the second alkylamine are 1:0.40 to 1:0.70 in terms of a molar ratio.

9. The nanoparticles of claim 1, wherein the nanoparticles have a specific surface area of 1200 to 1900 m²/g and a pore volume of 0.4 to 0.6 cm3/g.

10. A method for preparing zeolitic imidazolate framework nanoparticles including dual defect structures, the method comprising steps of:
preparing a first mixture by mixing a metal precursor and an imidazole-based ligand compound;
preparing a second mixture by mixing the first mixture with a polar solvent; and
mixing the second mixture with an alkylamine ligand including a first alkylamine and a second alkylamine which have different numbers of carbon atoms.

11. The method of claim 10, wherein the metal precursor includes an acetate salt of a metal, the amounts of the metal precursor: the imidazole-based ligand; and the alkylamine ligand used are 1:1.20 to 2.20:4 to 6 in terms of a molar ratio, and the amounts of the first alkylamine and the second alkylamine used are 3:7 to 7:3 in terms of a molar ratio.

12. The method of claim 11, wherein the metal precursor includes zinc acetate, the first alkylamine includes tributylamine, the second alkylamine includes triethylamine, and the amounts of the first alkylamine and the second alkylamine used are 3:7 to 5:5 in terms of a molar ratio.

13. A hybrid membrane comprising:
a polymer matrix; and
nanoparticles according to claim 1 dispersed in the polymer matrix.

14. The hybrid membrane of claim 13, wherein the content of the nanoparticles in the membrane is 30% by weight to 60% by weight, and the polymer matrix is formed by including any one selected from the group consisting of polyimide, polysulfone (PSF), polyethersulfone (PES), cellulose acetate (CA), polydimethylsiloxane (PDMS), and polyvinyl acetate (PVAc).

15. A gas separation method comprising a step of separating one or more gases from a mixed gas containing two or more gases using the hybrid membrane according to claim 13.
